(19) United States
(12) Patent Application Publication
(10) Pub. No.: US 2011/0244951 A1
(43) Pub. Date: Oct. 6, 2011

(54) SKILLED-BASED, FINITE POOL WAGERING GAME AND METHOD OF CONDUCTING THE SAME

(76) Inventor: Edwin W. Shaw, Burnaby (CA)

(21) Appl. No.: 13/076,221

(22) Filed: Mar. 30, 2011

Related U.S. Application Data
(60) Provisional application No. 61/319,699, filed on Mar. 31, 2010.

(51) Int. Cl. A63F 9/24; A63F 13/00

(52) U.S. Cl. 463/26; 463/30; 463/42

(57) ABSTRACT

A system and method wherein players play skill-based games over player terminals linked to a central system forming a game network. If the player accomplishes the skill-based task within an allotted time period, the player wins a game award and bonus prize. If the player fails to accomplish the skill-based task within the allotted time period, the player does not win the pre-determined game prize and the bonus prize is placed into a bonus prize pool which is available to be won by any player on the network who subsequently accomplishes a skill-based task in an allotted time period. The bonus prize pool increases as players over the network fail to accomplish the skill-based tasks within the allotted time period. The system and method allows games of chance based on finite pools to maintain proper winning percentages. Random number generator skill-based games may also benefit from the system and method.

### CROSS-REFERENCE TO RELATED APPLICATIONS

This application claims the benefit of U.S. Provisional Patent Application No. 61/319,699 filed on Mar. 31, 2010.

### FIELD OF THE INVENTION

The embodiments of the present invention relate to a finite pool wagering game configured to fund a payout pool with loses of potential payouts suffered by players unable to accomplish skill-based tasks in an allotted time period.

### BACKGROUND

Many gaming jurisdictions offer traditional pull tab and scratch off games in electronic formats played via game terminals linked to a central system which transmits the outcomes to the terminals. Such games have a finite pool of outcomes. That is, for each block of games provided, there are a certain number of winners (comprising different levels of winning amounts) and losers. Therefore, it is known in advance exactly how much profit the operator will generate once all outcomes have been exhausted. Outcomes of finite pool games are normally based on pure chance or luck.

While the finite pool games have been successful, they do suffer from drawbacks including lack of excitement and player interactivity.

Thus, there is a need to improve finite pool games by, for example, incorporating more excitement and player interactivity.

### SUMMARY

Accordingly, one embodiment of the present invention incorporates a skill-based component in finite pool games. In one embodiment, the skill-based component is a matching exercise which the player must complete in an allotted time period (e.g., 10 seconds). Should the player successively complete the matching exercise within the allotted time period, the player wins a pre-established payout selected and, in some instances, revealed to the player prior to the game being played. If the player is not able to successively complete the matching exercise within the allotted time period, the pre-established payout or at least a portion of the pre-established payout is placed into a bonus prize pool. The bonus prize pool is funded by games played at all player terminals forming part of game network such that the bonus prize pool increases until it is awarded to a next player on the game network is able to complete a matching exercise within an allotted time period. In this manner, the total payouts for the finite pool of outcomes remain fixed.

Certain embodiments of the present invention are played via a series of networked game terminals wherein the terminals include at least a display and player user interface. A controller/server or similar means in communication with the game terminals is responsible for managing the games, including transmitting the game outcomes to the terminals, and awarding conventional payouts and the bonus prize pool.

While the skill-based component described above and throughout this specification involves matching, any skill-based component may be used with the embodiments of the present invention. For example, the skill-based component may be based on memory, dexterity, pattern recognition, hand-eye coordination or other human action. Skill-based games using random number generators may also benefit from the system and method described herein as described more fully below.

Other variations, embodiments and features of the present invention will become evident from the following detailed description, drawings and claims.

### BRIEF DESCRIPTION OF THE DRAWINGS

FIGS. 1a-1f illustrate various screen shots of a first instant win game of the type which may be played and conducted according to the embodiments of the present invention;

FIGS. 2a-2e illustrate various screen shots of a second instant win game of the type which may be played and conducted according to the embodiments of the present invention;

FIGS. 3a-3d illustrate various screen shots of a third instant win game of the type which may be played and conducted according to the embodiments of the present invention;

FIGS. 4a-4d illustrate various screen shots of a fourth instant win game of the type which may be played and conducted according to the embodiments of the present invention;

FIGS. 5a-5e illustrate various screen shots of a fifth instant win game of the type which may be played and conducted according to the embodiments of the present invention;

FIGS. 6a and 6b illustrate block diagrams of system for facilitating the embodiments of the present invention;

FIG. 7 shows a flow chart detailing one method of play according to the embodiments of the present invention; and

FIG. 8 shows a flow chart detailing a method of play according to another embodiment of the present invention.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

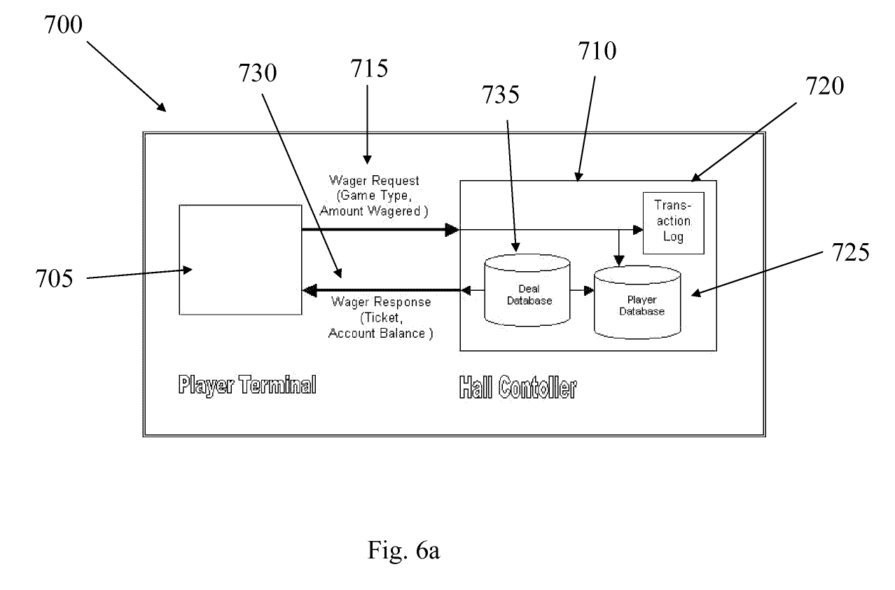

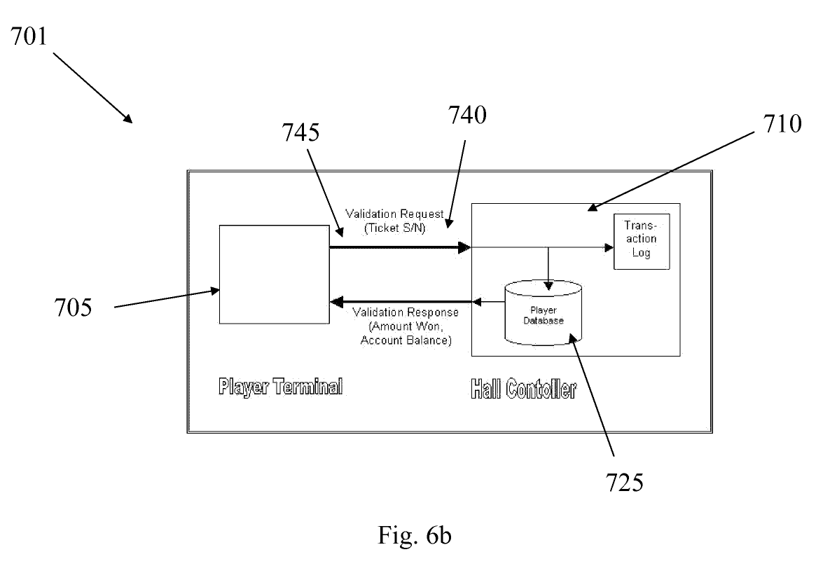

The games are played on gaming devices using conventional technology such as processors, controllers, servers, memory, game stations and terminals, including displays and player interfaces comprising game buttons and touch screens. The player terminals comprise electronic gaming machines with or without processing power (i.e., dumb or smart), hand-held devices (e.g., smart phones) and the like. FIGS. 6a and 6b show block diagrams of exemplary system architectures having central controller/server maintaining one or more databases in communication with player terminals, gaming terminals, gaming device or gaming machines which can be connected via wires or wirelessly forming a game network. The game network may be a local area network (LAN) or wide area network (WAN).

The embodiments of the present invention are suitable for class II and class III gaming devices. Class II games utilize bingo patterns to generate traditional game outcomes (e.g., slots). Class III games utilize random number generators (RNGs) to generate game outcomes.

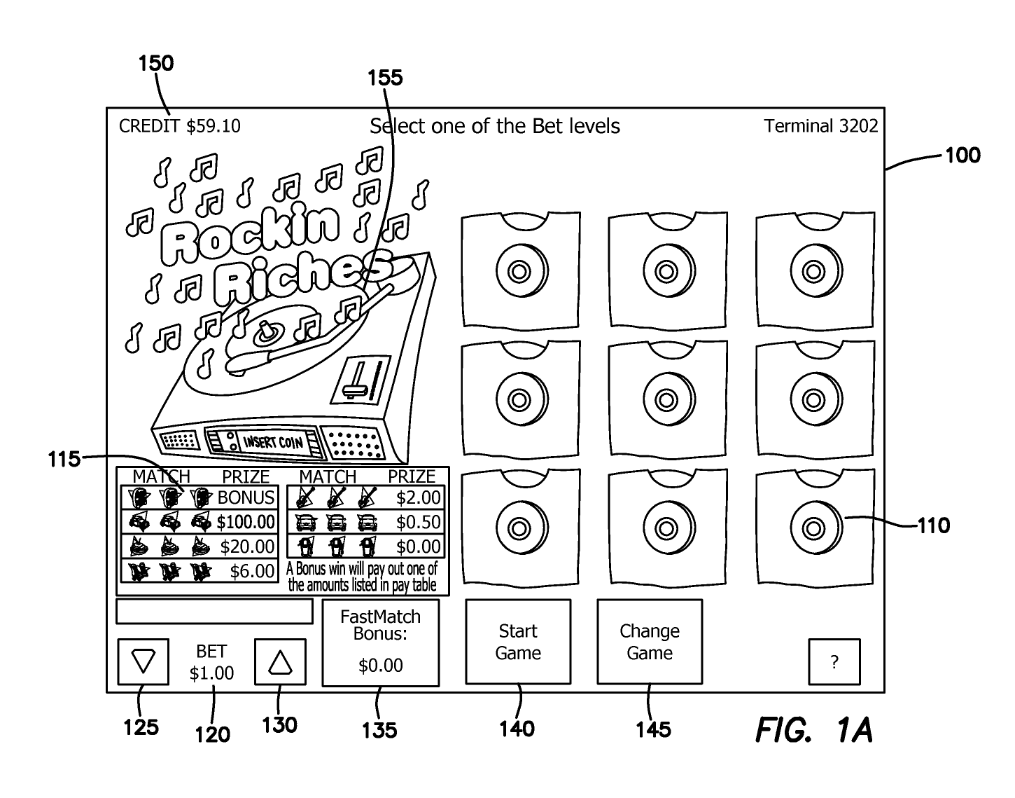

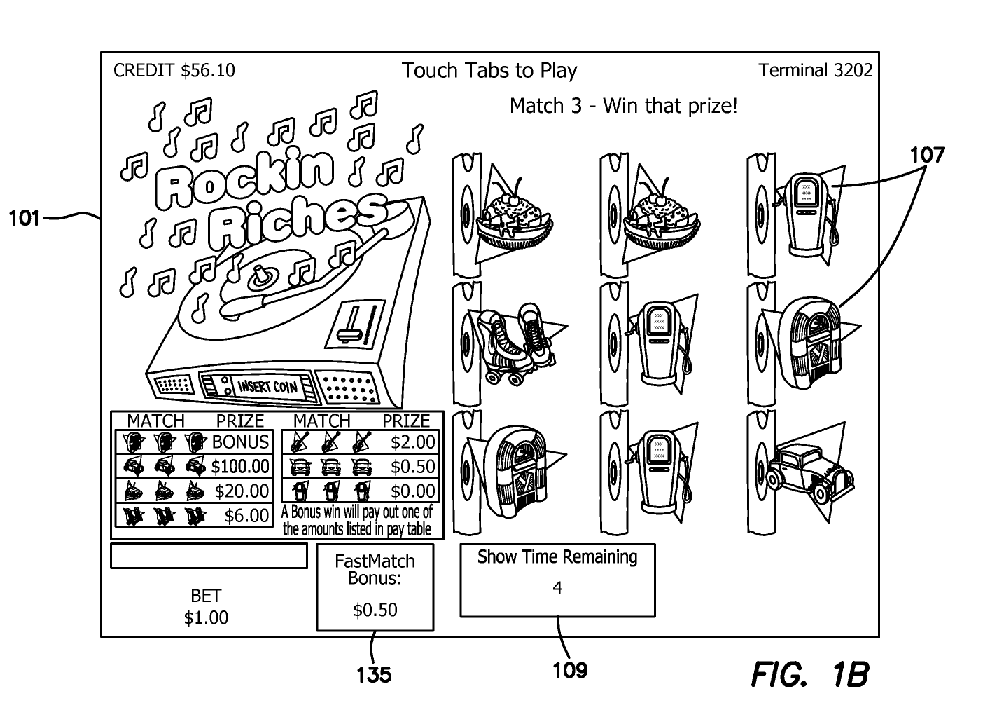

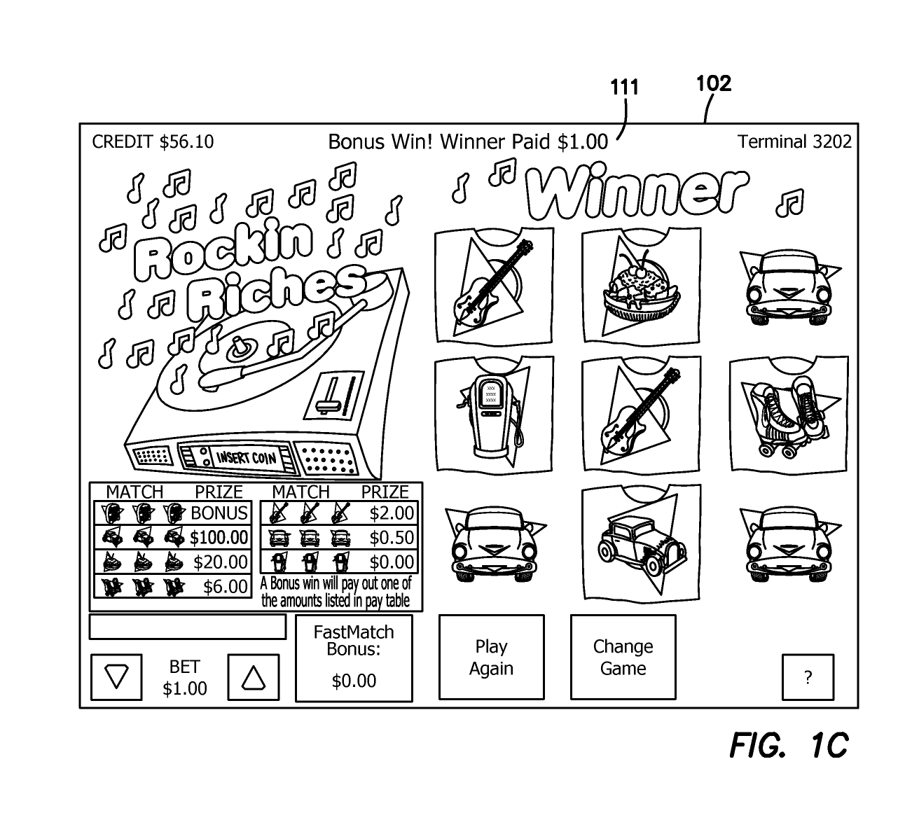

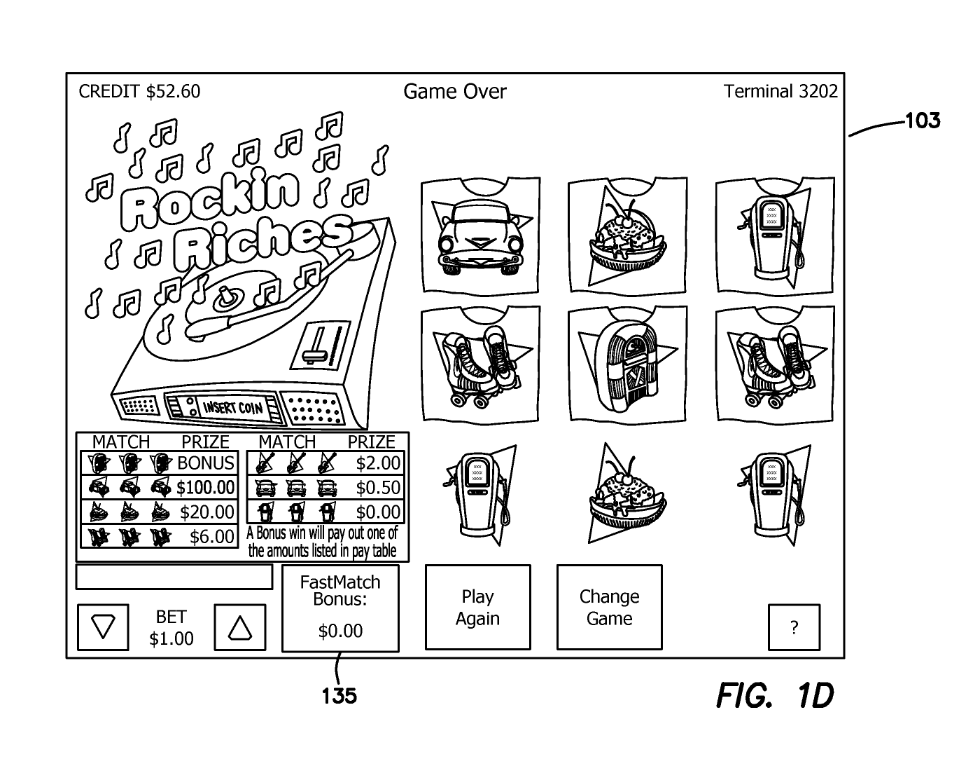

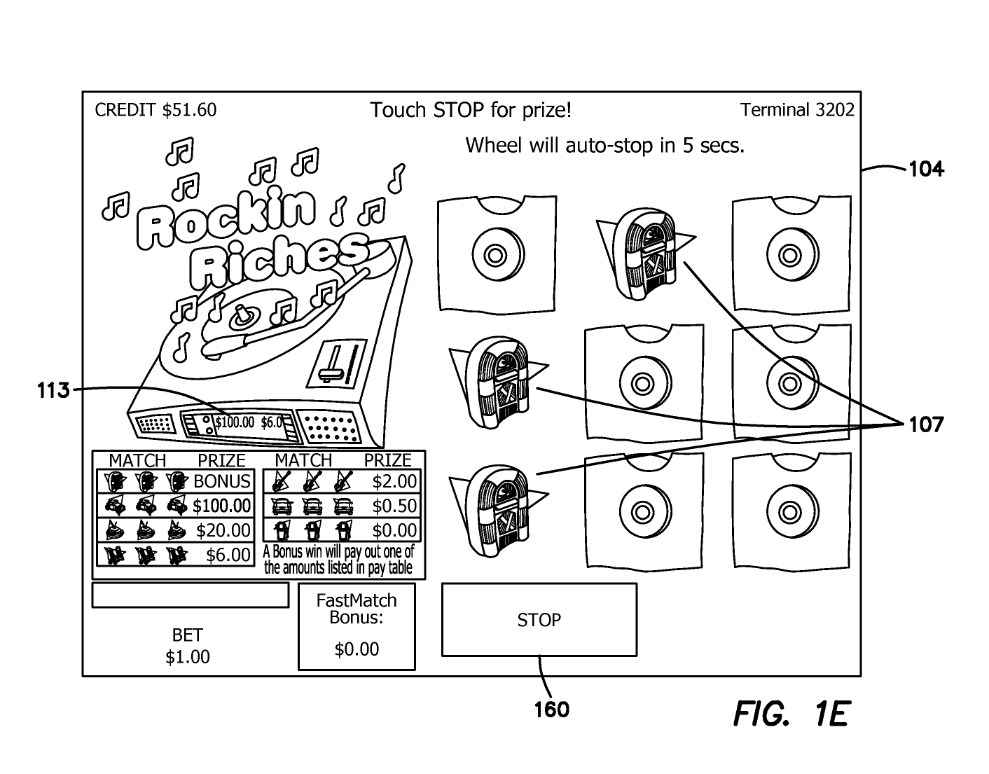

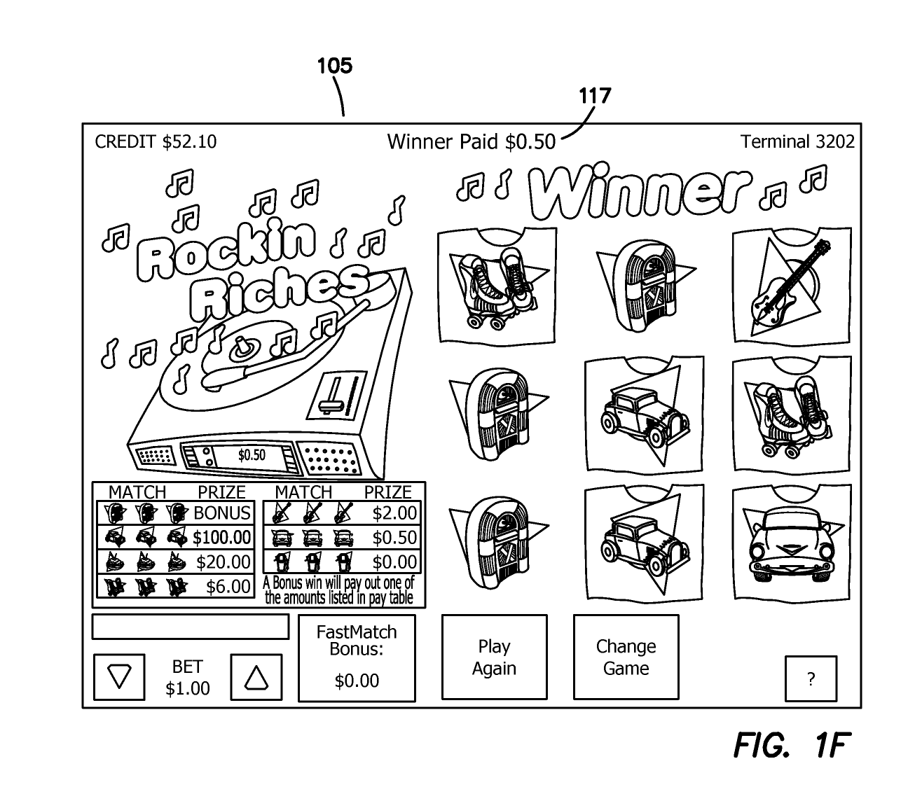

Initial reference is made to FIGS. 1a-1f illustrating screen shots 100-105 showing an instant win game fancifully named “Rockin Riches.” Screen shot 100 shows a matrix of game indicia concealed with nine record covers 110, pay table 115, bet amount 120, up bet arrow 125, down bet arrow 130, bonus prize pool 135, start game icon 140, change game icon 145, game credits 150 and game theme 155. The player starts the game by pressing the start game icon 140 on the screen. Responsive to the start game icon 140 being pressed, the wager is made and the game outcome potential and associated prize amount is selected from the finite pool or deal from the central system comprising, for example, a controller in the form of a data server maintaining one or more databases. Should the player accomplish the skill-based task within an allotted time period, the player wins the prize amount. If the player fails to accomplish the skill-based task in the allotted time period, the prize amount is added to a bonus prize pool winnable by any player playing a game on the game network. In screen shot 101, the game indicia 107 are revealed to the player for a pre-established time period counted down by counter 109. In this embodiment, at least three game indicia are identical (gas pumps in this instance). In addition, the bonus prize pool amount is now 0.50¢. Screen shot 102 shows a winning outcome after the player successively locates the three matching game indicia 107 (automobiles in this instance) within the allotted time period (e.g., 10 seconds). Responsive to the win, the player is awarded $1.00 111 comprising 0.50¢ for the game played and 0.50¢ from the bonus prize pool 135 (i.e., the player is the first player on the game network to accomplish a skill-based task since the bonus prize pool was funded). During the allotted time period the player is able to select any three record covers 110 to reveal the concealed game indicia 107. If all three record covers 110 do not reveal matching game indicia 107, the record covers 110 again turn over to conceal the game indicia 107 and the player is able to try again until the allotted time period ends. In one embodiment, the game indicia 107 do not move locations such that the player is in some cases able to systematically locate the three matching game indicia 107. Alternatively, it is conceivable that the game indicia 107 may be reorganized after each revelation of game indicia 107. Screen 103 shows a losing outcome based on the player being unable to locate the three matching game indicia 107 within the allotted time period. Responsive to the losing outcome, the bonus prize pool amount 135 is updated from $0 to 0.50¢ across all linked game terminals on the network. In other words, the bonus prize pool 135 is the aggregate of all non-winning outcomes resulting from the failure of players to accomplish skill-based tasks within allotted time periods. The bonus prize pool 135 increases by the prize amount selected from the finite pool until a next player on a game terminal linked to the network accomplishes a skill-based task within an allotted time period.

In some embodiments, the underlying game may also include a bonus round which is triggered if the three matching game indicia 107 are of a pre-established type (juke boxes in this instance) and the player is able to locate the matching game indicia 107 during the allotted time period. Screen 104 shows the three matching juke box game indicia 107 triggering the bonus game. The bonus game is a non-skill game wherein potential winning bonus amounts 113 scroll past until the player presses the stop icon 160 or a pre-established time period (e.g., 5 seconds) expires at which time a bonus prize is displayed. The displayed bonus prize is predetermined and does not change regardless of when the stop icon 160 is depressed or the allotted time period expires. Screen shot 105 shows the player winning the 0.50¢ bonus 117.

The game outcomes illustrated in FIGS. 1a-1f, as well as those described below, may be selected and generated via Class II and Class III systems.

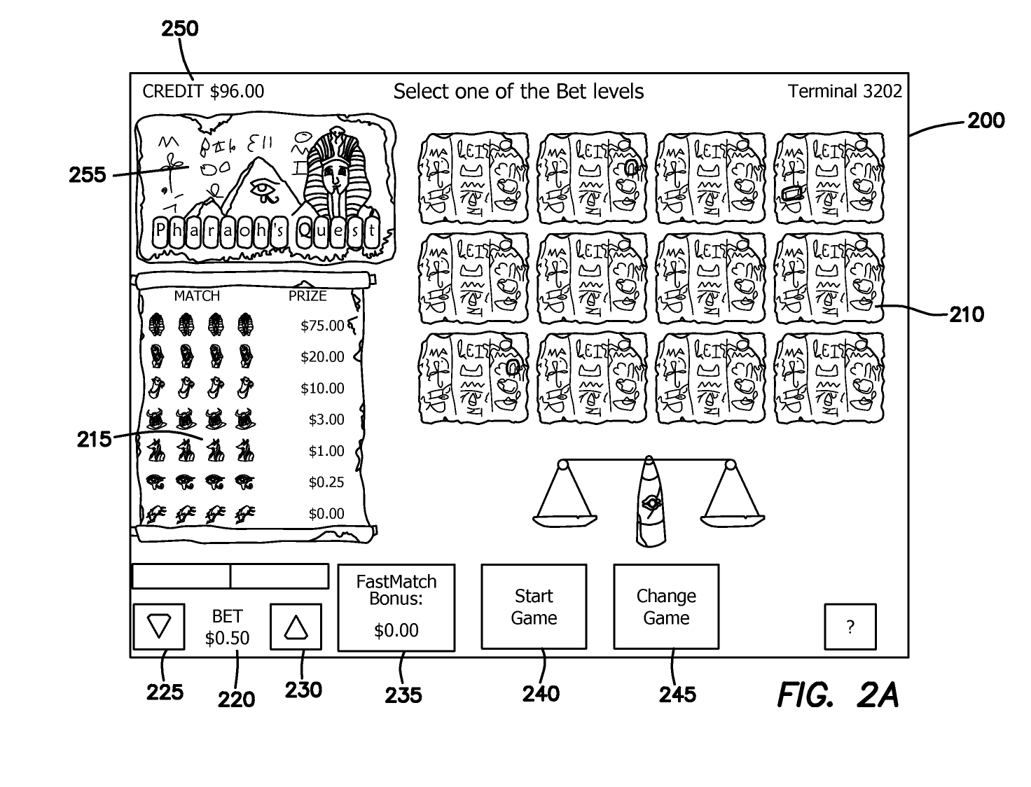

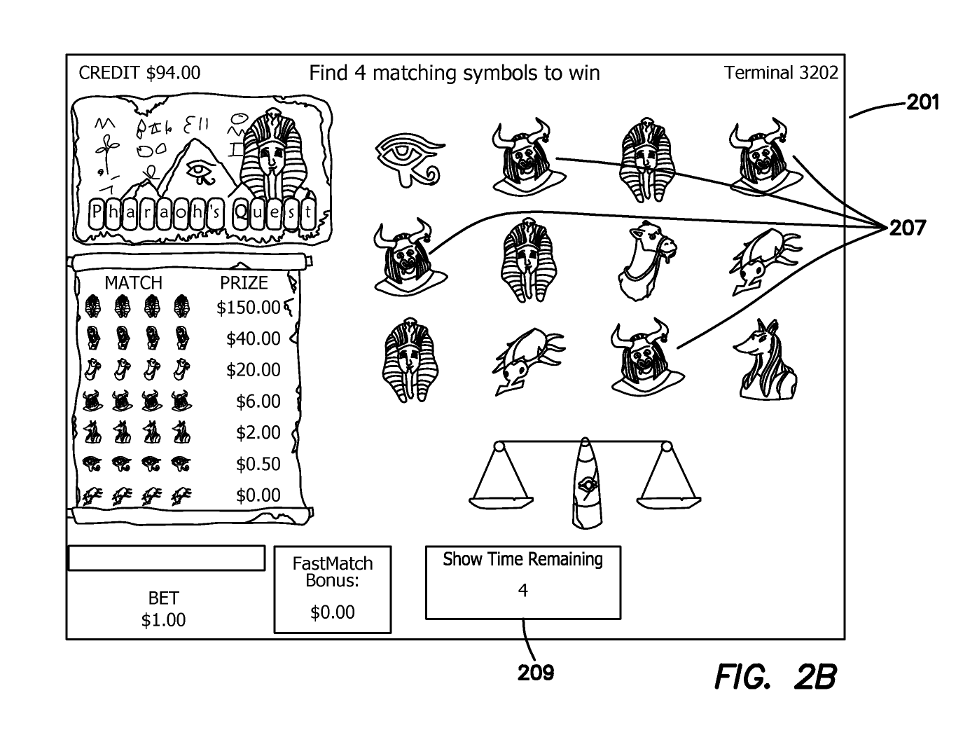

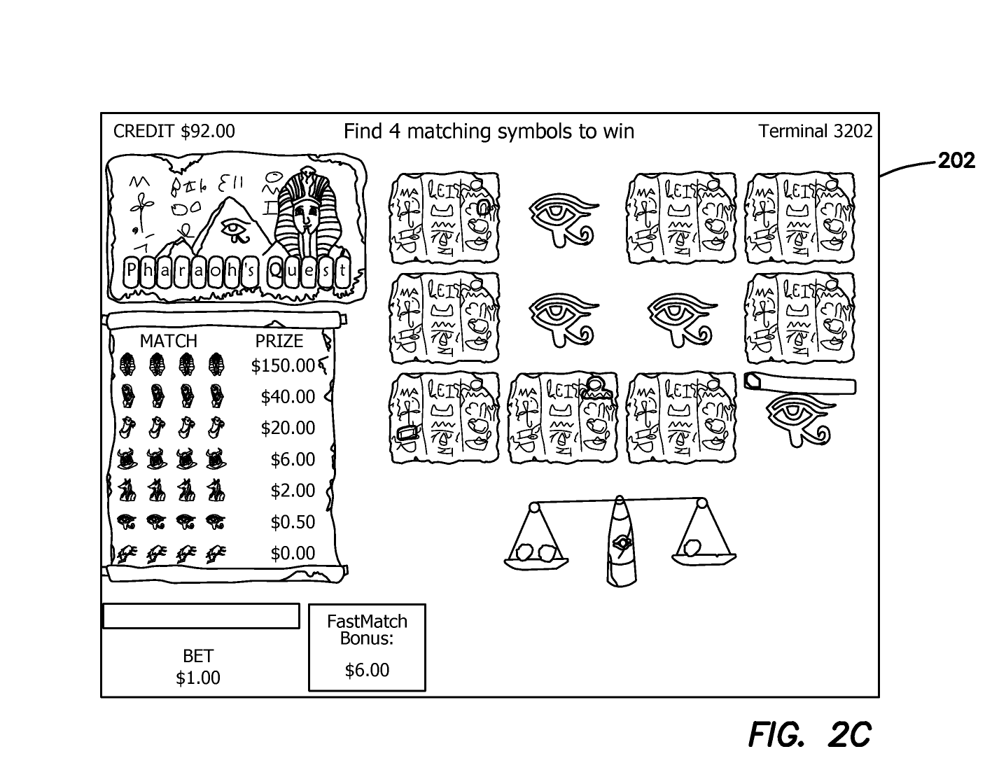

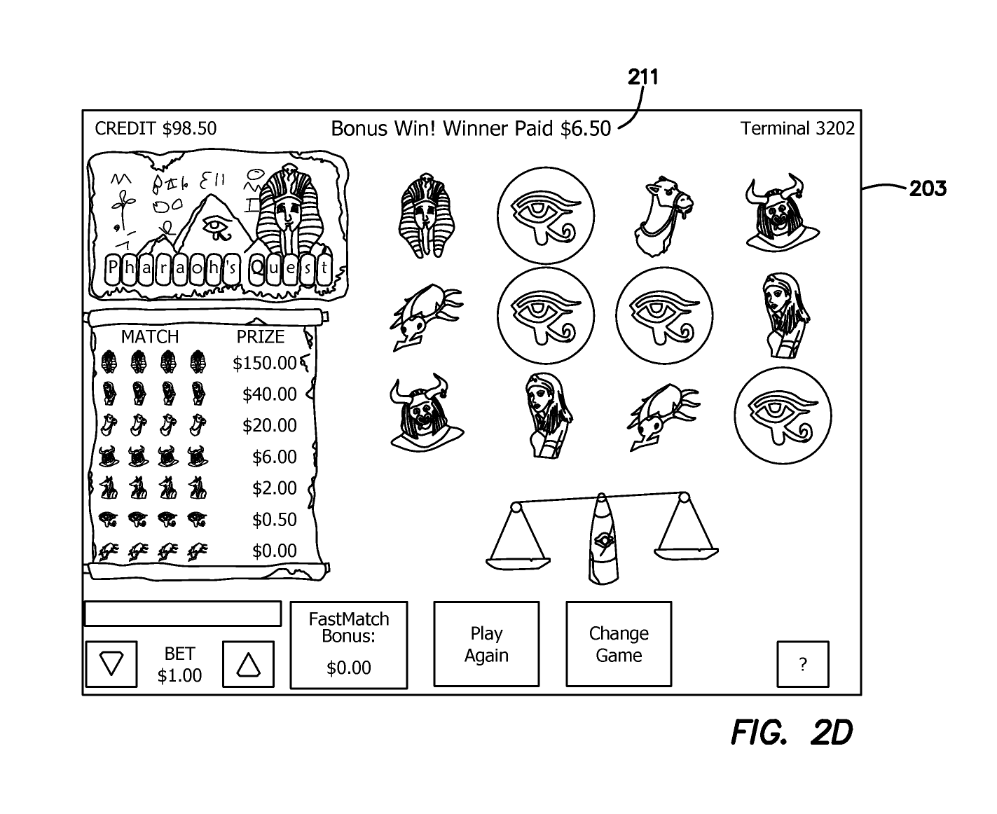

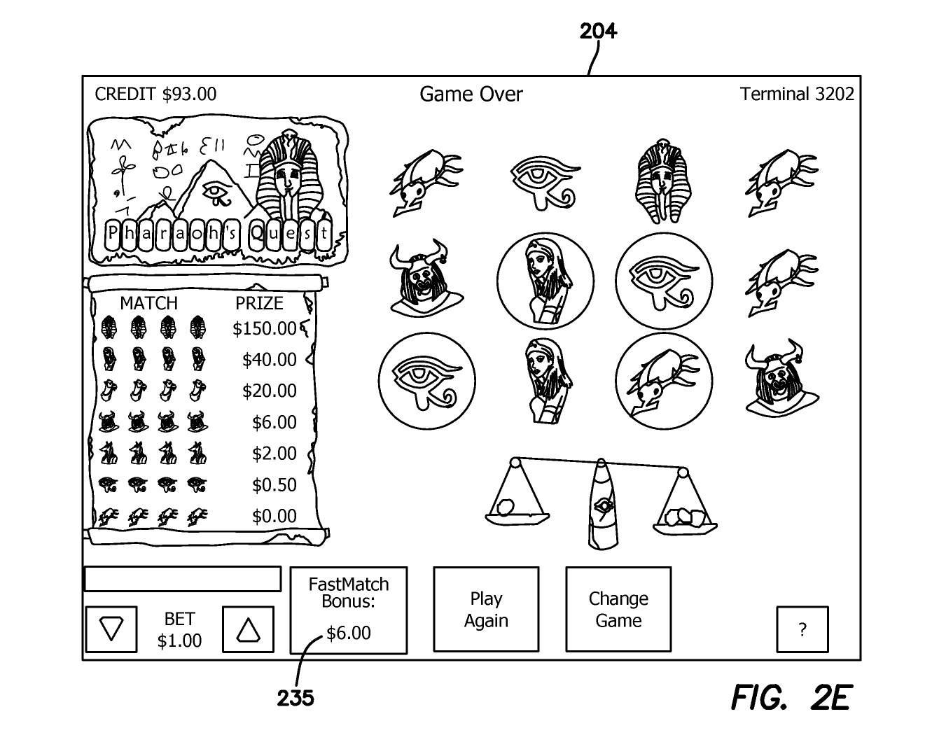

FIGS. 2a-2e illustrate screen shots 200-204 showing an instant win game fancifully named “Pharoah's Quest.” Screen shot 200 shows a matrix of game indicia concealed with twelve hieroglyphic tablets 210, pay tables 215, bet amount 220, up bet arrow 225, down bet arrow 230, bonus prize pool 235, start game icon 240, change game icon 245, game credits 250 and game theme 255. As shown in screen 201, in this instance there are four matching game indicia 207 in the form of bull's heads which must be matched in an allotted time period to win a prize. Screens 202 and 203 show winning outcomes after the player successively locates four matching game indicia 207 (scorpions in this instance) within the allotted time period as counted down by counter 209. Responsive to the win the player is awarded $6.50 211 comprising 0.50¢ for the game played and $6.00 from the bonus prize pool 235 (which was funded by prize amounts from previous non-winning game outcomes across the game network). Screen 204 shows a losing outcome based on the player being unable to locate the four matching game indicia 207. Responsive to the losing outcome, the bonus prize pool amount 235 is updated to $6.00 across all linked game terminals.

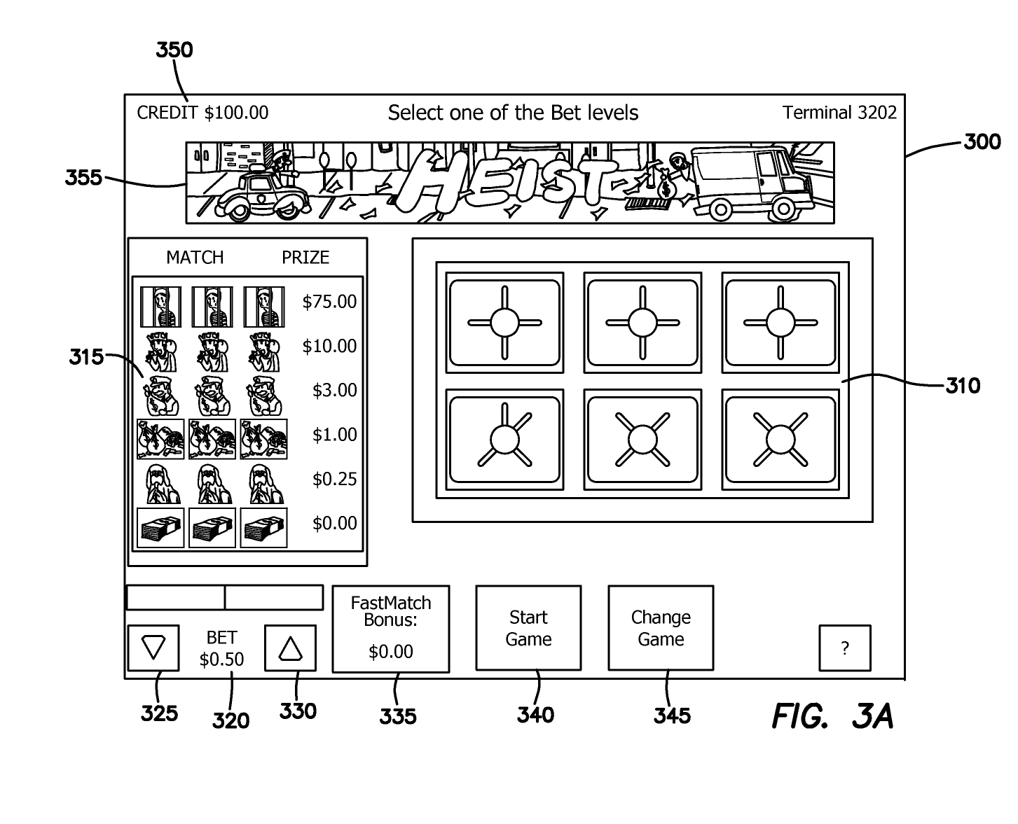

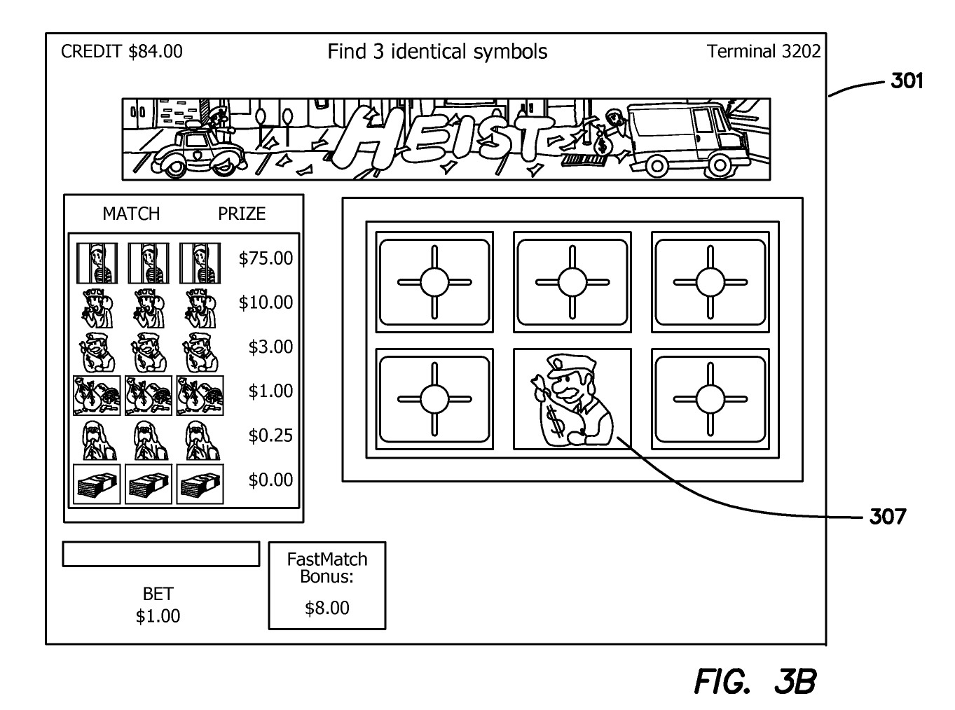

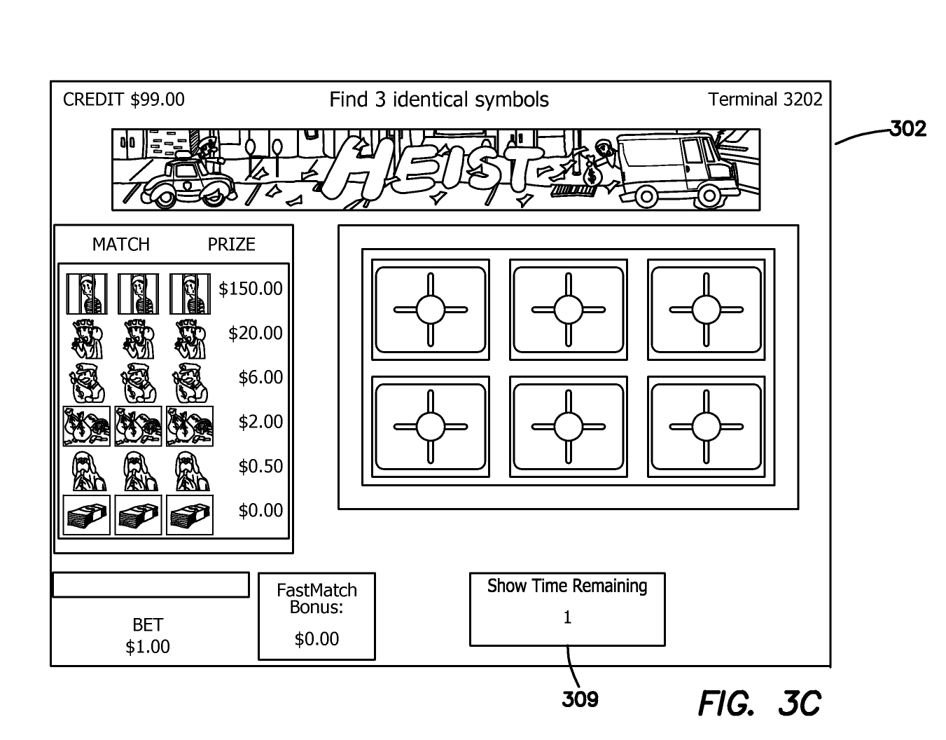

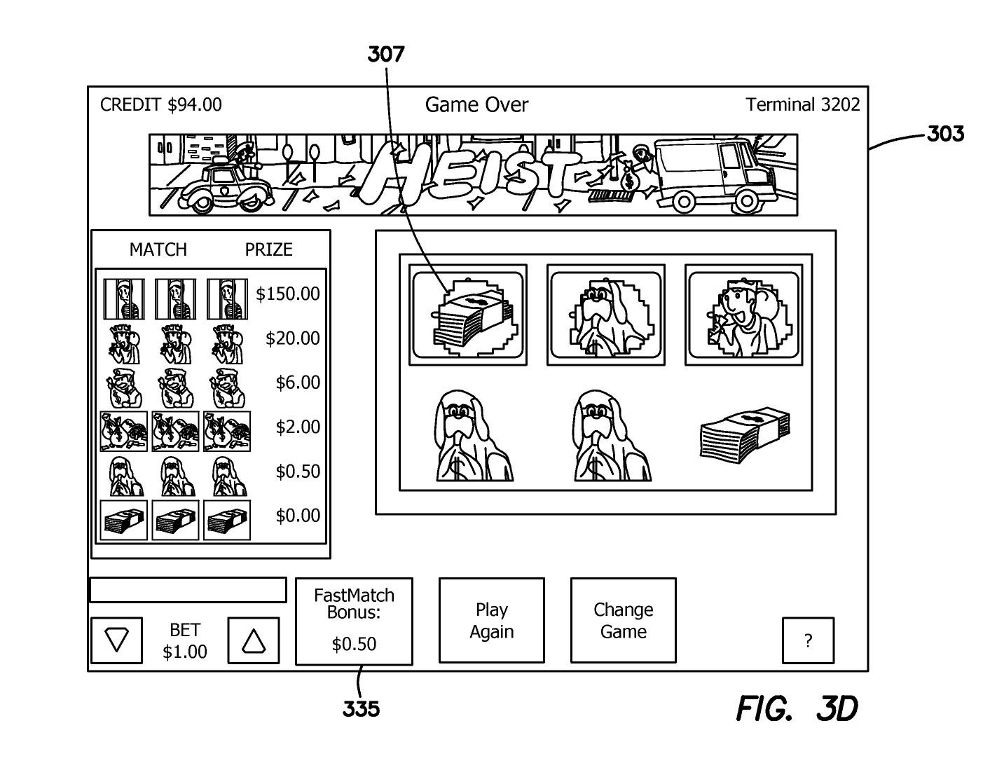

FIGS. 3a-3d illustrate screen shots 300-304 showing an instant win game fancifully named “Heist.” Screen shot 300 shows matrix 310, pay table 315, bet amount 320, up bet arrow 325, down bet arrow 330, bonus prize pool 335, start game icon 340, change game icon 345, game credits 350 and game theme 355. Screen shot 300-303 show that the game displayed like those described above except there are six game indicia 307 concealed and each game indicia 307 is revealed singularly rather than simultaneously. The game is played in the same manner as those described above under an allotted time counted own by the counter 309.

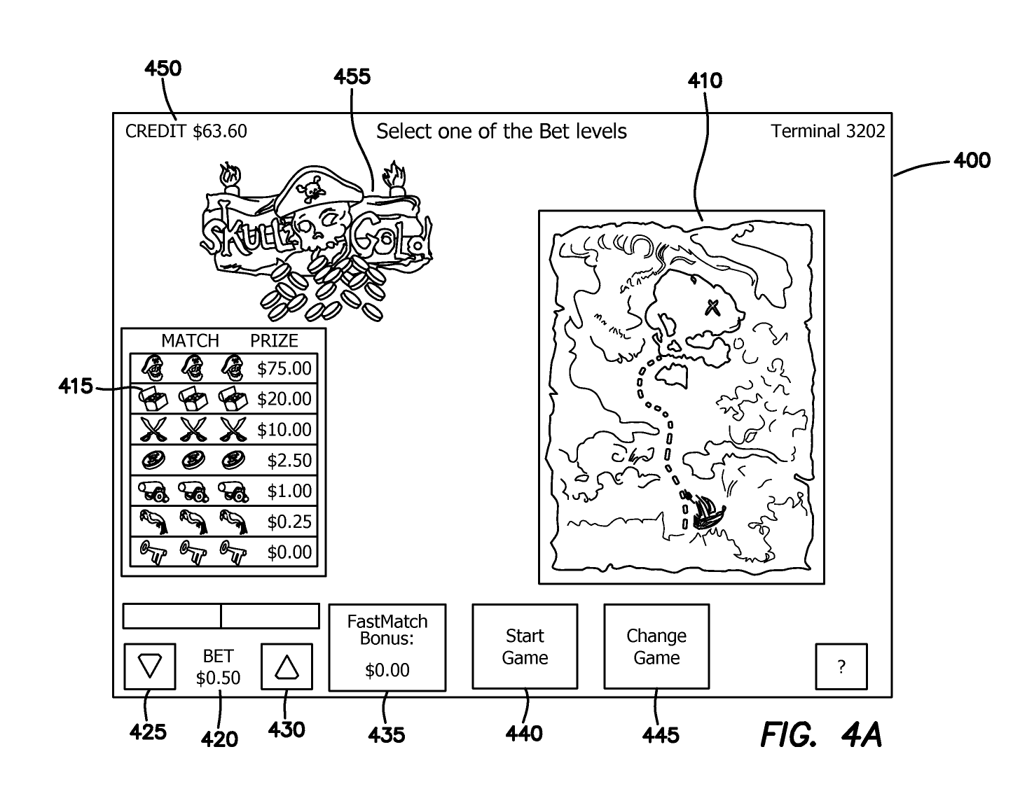

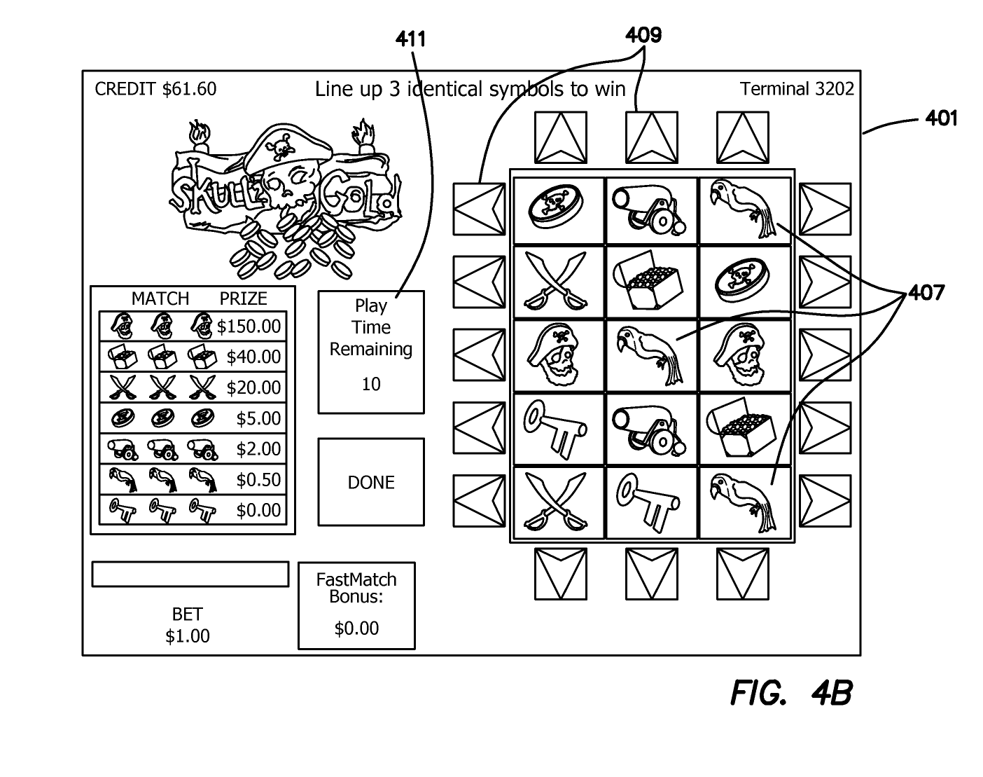

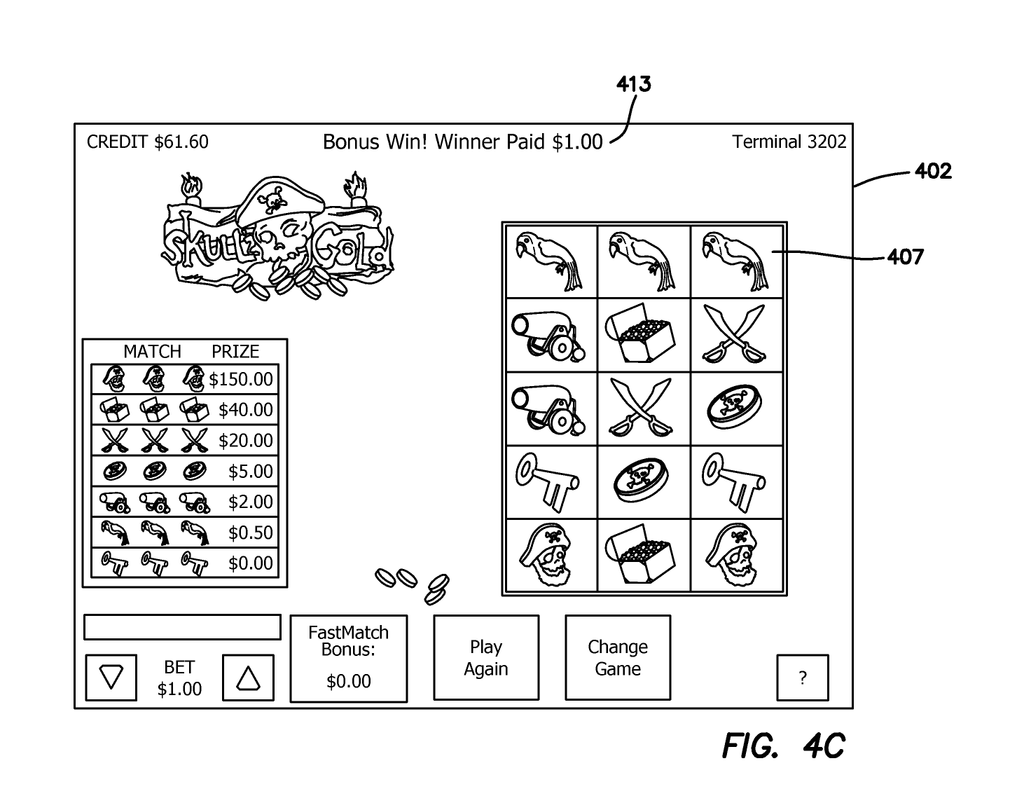

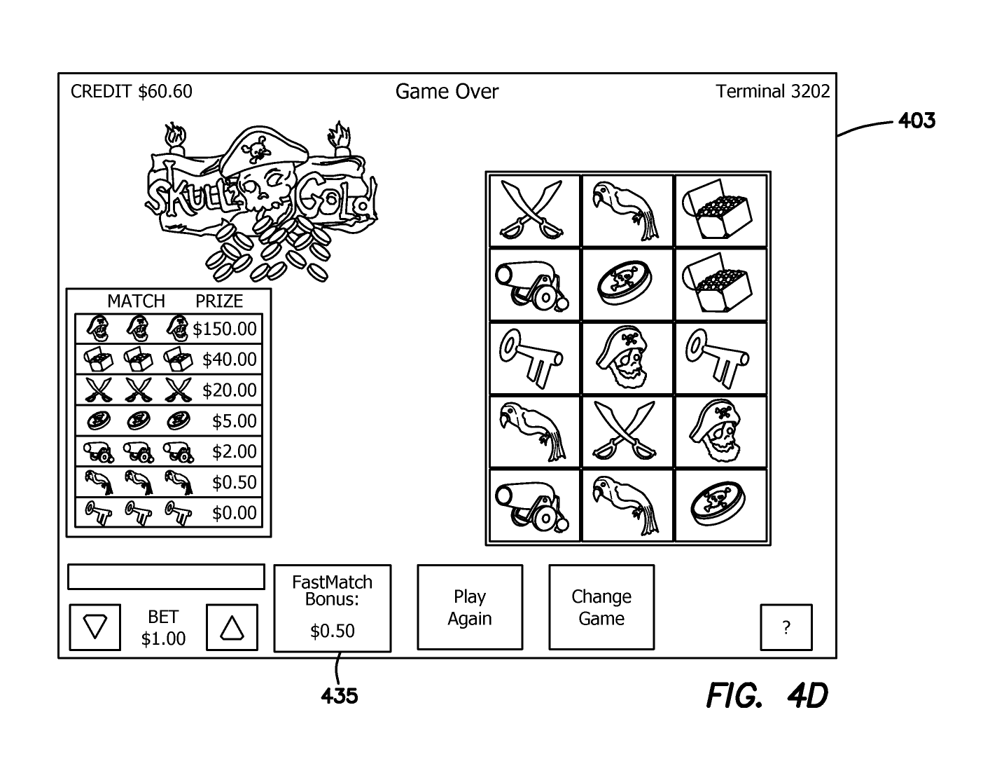

FIGS. 4a-4d illustrate screen shots 400-403 showing an instant win game fancifully named “Skull Gold.” Screen shot 400 shows a map 410 concealing a matrix of game indicia 407, pay table 415, bet amount 420, up bet arrow 425, down bet arrow 430, bonus prize pool 435, start game icon 440, change game icon 445, game credits 450 and game theme 455. As shown in screen 401, in this instance there are again three matching game indicia 407 in the form of parrots which must be located and, in this embodiment, also horizontally aligned using directional arrows 409 in an allotted time period to win a prize. Screen 402 shows a winning outcome after the player successively locates and horizontally aligns the three matching game indicia 407 (parrots in this instance) within the allotted time period as counted down by counter 411. Responsive to the win the player is awarded $1.00 413 comprising 0.50¢ for the game played and $0.50¢ from the bonus prize pool 435. Screen 403 shows a losing outcome based on the player being unable to locate and horizontally align the matching game indicia 407. Responsive to the losing outcome, the bonus prize pool amount 435 is updated from $0 to $0.50¢ across all linked game terminals.

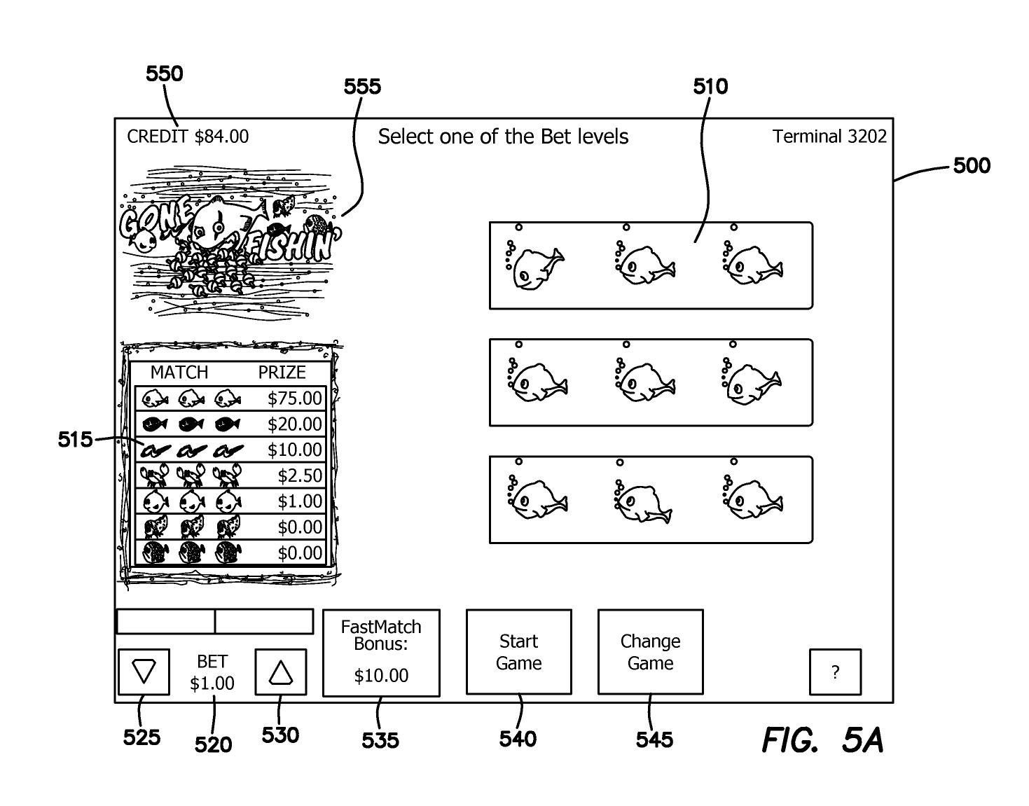

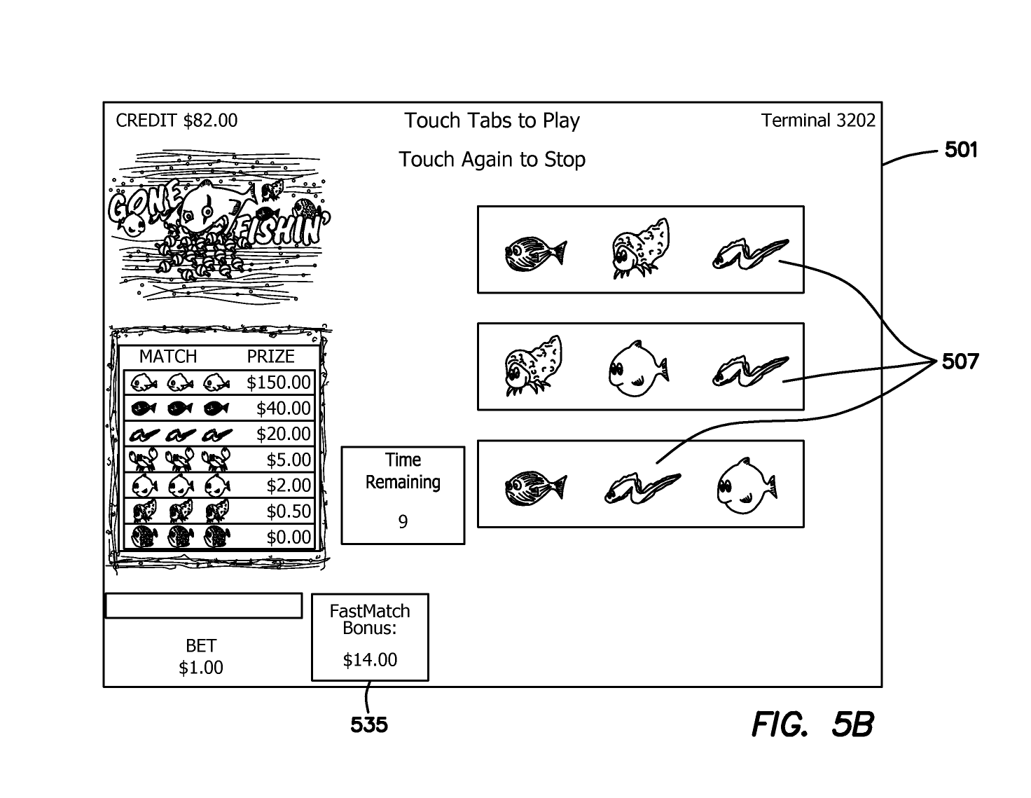

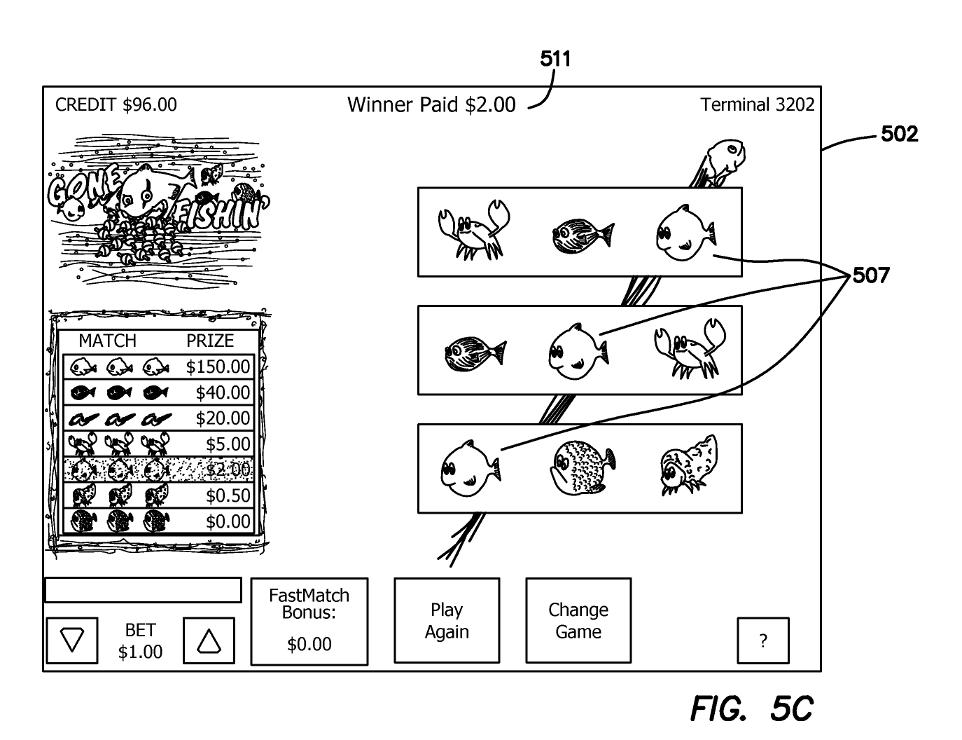

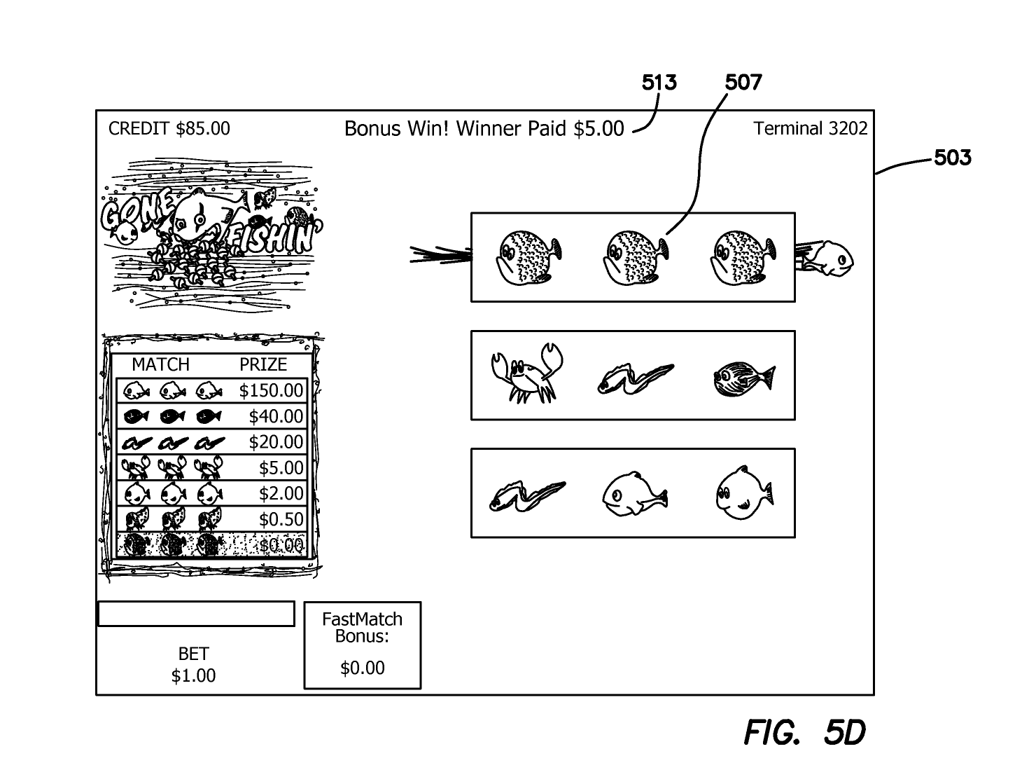

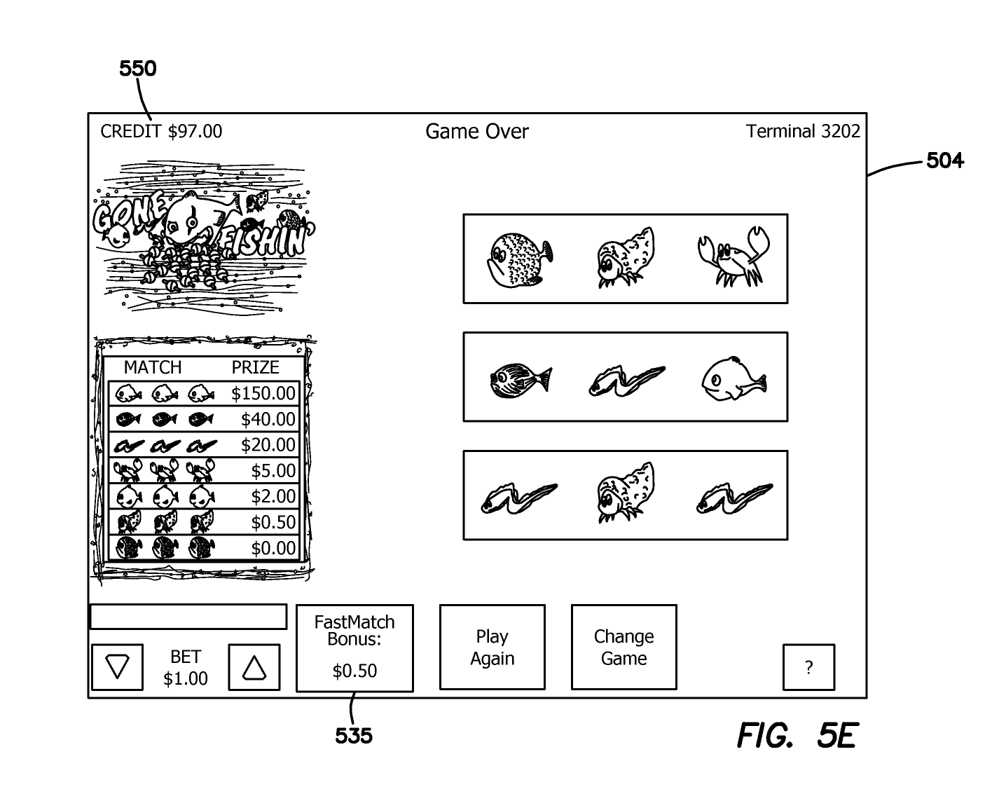

FIGS. 5a-5e illustrate screen shots 500-504 showing an instant win game fancifully named “Gone Fishing.” Screen shot 500 shows a matrix of game symbols 510, pay table 515, bet amount 520, up bet arrow 525, down bet arrow 530, bonus prize pool 535, start game icon 540, change game icon 545, game credits 550 and game theme 555. As shown in screen 501, in this instance there are again three matching game indicia 507 in the form of reels which must be located and, in this embodiment, also aligned horizontally, vertically or diagonally. In this embodiment, each row of game indicia 507 is replaced with another row of game indicia 507. The player is required to press the screen once three matching game indicia 507 are aligned horizontally, vertically or diagonally thereby stopping the game indicia from changing. If three matching game indicia are not aligned horizontally, vertically or diagonally, the player must press the screen again to start the process once again. As with the other skill-based tasks, the player has an allotted period of time to accomplish the task. Failure to do so causes the potential winnings to be deposited into the bonus prize pool 535. Screen 502 shows three matching game indicia 507 in the form of fish aligned diagonally. Responsive to the winning outcome, the player is awarded $2.00 511 comprising $2.00 for the game played (there is no bonus pool prize). Screen 503 shows three matching game indicia 507 aligned horizontally and the player being awarded $5.00 513 comprising $5.00 from the bonus prize pool 535. Screen 504 shows a losing outcome based on the player being unable to locate and align the matching game indicia 507. Responsive to the losing outcome, the bonus prize pool amount 535 is updated from $0 to $0.50¢ across all linked game terminals.

FIGS. 6a and 6b show system architectures 700 and 701 including a player terminal 705 and central system 710. In FIG. 6a the player terminal 705 communicates with the central system or controller 710 via a wired or wireless connection. When a wager request 715 is sent to the central system 710 from the player terminal 705 it contains the game type and the wager amount. The game type and wager amount is logged in transaction log 720 and stored in a player database 725. Responsive to the wager request 715, the central system 710 sends a wager response transaction 730 to the player terminal 705. The wager response transaction 730 contains the ticket from the deal database 735 and updated player balance.

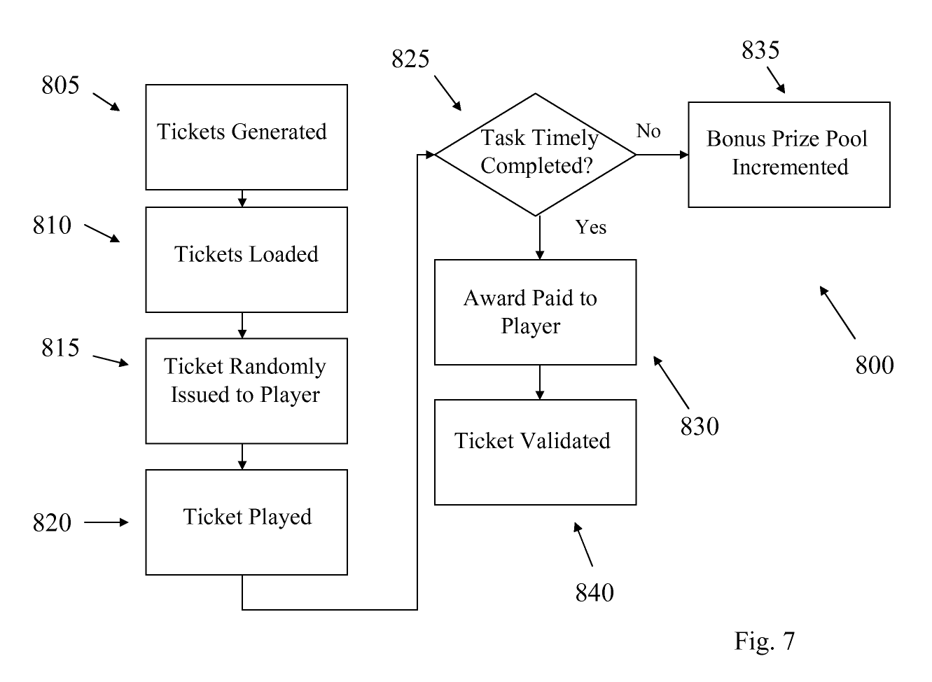

FIG. 7 shows a flow chart 800 detailing one method of playing/conducting the games of the embodiment of the present invention. At 805, a deal or finite set of instant win tickets is generated. The deals are created by a separate stand-alone software utility and may be any size desired. The deals are creating by first determining the minimum and maximum wager level (e.g., 0.25¢ to $1.00), the prize levels, number of winning tickets at each prize level and the associated prize levels. A deal is created for each prize level within a game so that there are multiple deals within a database for each game (e.g., a deal is issued for each 0.25¢, 0.50¢, 0.75¢ and $1.00 wager level for each game). At 810, once generated, all tickets are placed in a binary file with tickets randomly listed and loaded onto a central system accessible by a gaming hall or the like.

At 815, a ticket is randomly issued to a player responsive to the player purchasing the ticket via a player terminal or placing a wager and initiating play. In other words, a game outcome and prize amount is pre-determined. The terminal includes a bill reader, coupon reader, or similar device for accepting monetary value which is converted into game credits from which wagers or purchases are debited. In one embodiment, tickets are randomly selected from the deal and issued using a number of inputs to seed a random number generator (RNG). When player initiates a game, a wager request transaction is sent the central system as shown in FIG. 6a. A seed determinant for the RNG is also sent from the player terminal in the wager transaction. The seed determinant is a single number combined from the x and y touch screen coordinates from the player's most recent touch and the time (in milliseconds) when the player terminal initiated the wager transaction message. The seed determinant is used by the central system in combination with the time to form another seed determinant number. The second seed determinant is then used to seed the RNG in order to obtain the random number for the ticket selection. Such a method eliminates predetermined selections.

At 820, the ticket is played during which the player undertakes the skill-based task associated with the subject game. The skill may relate to pattern recognition, memory, trivia, dexterity, hand-eye coordination and the like. The skill may need to be accomplished in a pre-established time period or until the skill-based component is otherwise terminated. At 825, it is determined if the player accomplished the skill task in the allotted time period. If so, at 830, the player wins the associated prize amount and any available bonus prize pool amount. If not, at 835, the player loses a game wager and the prize amount associated with the played game is added to the bonus prize pool amount.

At 840, the ticket is validated. The validation begins when the player terminal 705 sends a validation request 735 to the central system 710 as shown in FIG. 6b. The validation request 740 contains a serial number associated with ticket. The central system 710 accesses the player database seeking the ticket corresponding to the serial number. The central system 710 plays the ticket to determine the winning level of the ticket, computes the amount won and updates the player balance. The central system 710 then sends a validation response 745 to the player terminal 705. The validation response 745 contains the amount won and the player balance after the win/loss. If a validation mismatch is found, it is logged into an exception file and the player terminal is automatically reset.

In one embodiment, the system allows the operator to set game parameters including game play price, pay tables (prize for each winning level, number of tickets in each winning levels and bonus rounds), deal size and progressive prizes. One such progressive is the bonus prize pool described herein but others comprise the inclusion of odds based on the number of tickets per deal and a percentage or fixed amount of the drop per game used to fund a progressive pool.

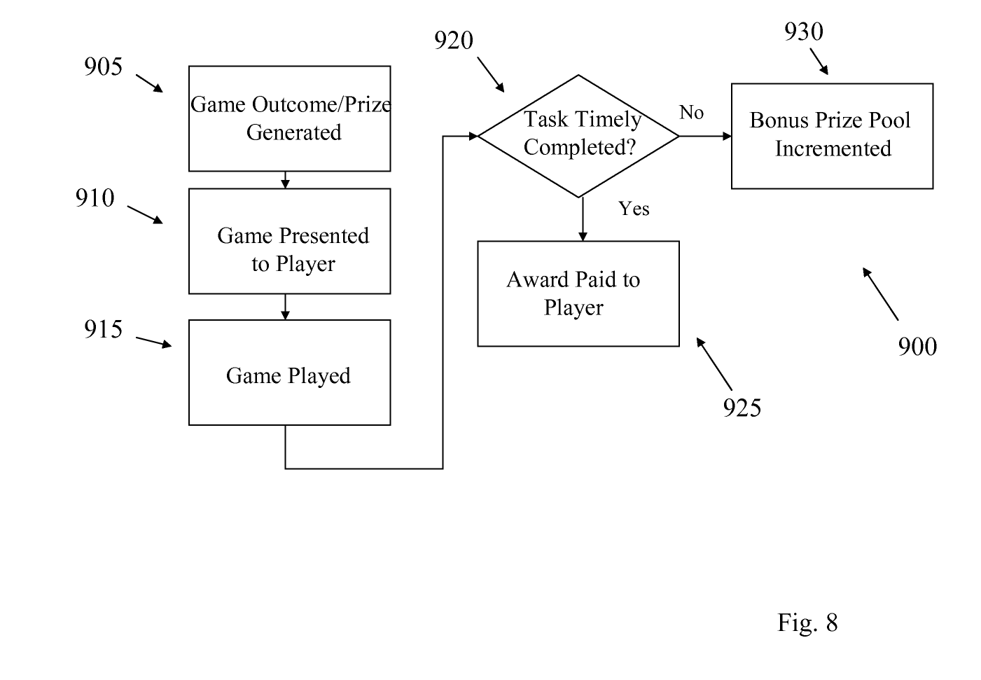

FIG. 8 shows a flow chart 900 detailing another method of playing/conducting a random number generator slot game according to the embodiment of the present invention. At 905, a randomly generated game outcome is generated. The game outcomes are generated by software on the gaming terminal or gaming server in the case of server-based gaming. The game outcome is determined by first determining the player wager level (e.g., 0.25¢ to $1.00), number of lines played and any other criteria used to determine the prize levels associated with the game to be played. In a random number generator skill-based game, a theoretical payout is set to a pre-established rate (e.g., 92%) and tested over a pre-established number of plays (e.g., 3 million). The testing is conducted under the premise that the player plays the perfect game (e.g., perfect skill), if not, the house gains the advantage. At 910, the wager and prize have been determined and utilized by the gaming terminal software to provide the game outcome and associated prize to the game terminal.

The game 915 is played during which the player undertakes the skill-based task associated with the subject game. The skill may relate to pattern recognition, memory, trivia, dexterity, hand-eye coordination and the like. The skill may need to be accomplished in a pre-established time period or until the skill-based component is otherwise terminated. At 920, it is determined if the player accomplished the skill-based task in the allotted time period. If so, at 925, the player wins a prize amount any available bonus prize pool amount. If not, at 930, the player loses a game wager and the prize amount associated with played game is added to the bonus amount prize pool. By applying the methodology described herein a proper winning percentage is maintained for RNG-based skill games.

Although the invention has been described in detail with reference to several embodiments, additional variations and modifications exist within the scope and spirit of the invention.

I claim:

1. A method of conducting a skill-based game comprising:
establishing a finite pool of game outcomes including monetary prizes;
accepting player wagers or ticket purchases via a player terminal in communication with a central system, said central system in communication with a plurality of player terminals forming a game network, said player terminals including at least a display and player interface;
selecting a monetary prize amount and game outcome from said finite pool of game outcomes;
presenting to the player a monetary prize that may be won if the player wins the skill-based game in an allotted time period;
via the display, presenting the skill-based game to the player;
providing an allotted time period for the player to attempt to accomplish said skill-based game via said player interface;
if the player wins the skill-based game in the allotted time period, awarding the player said monetary prize and any bonus prize pool amount; and
if the player fails to win the skill-based game in the allotted time period, not awarding the player said monetary prize and adding said monetary prize amount to said bonus prize pool which is awarded to a next player on any player terminal on the game network to win a skill-based game in an allotted time period.

2. The method of claim 1 further comprising establishing the skill-based game on one or more of the following:
(i) memory;
(ii) trivia;
(iii) dexterity;
(iv) hand-eye coordination; and
(v) pattern recognition.

3. The method of claim 1 further comprising presenting a timer to the player via said display.

4. A method of conducting a skill-based game comprising:
establishing a theoretical payout rate based on perfect skill play;
accepting player wagers via a player terminal in communication with a central system, said central system in communication with a plurality of player terminals to form a game network, said player terminals including at least a display and player interface;
randomly determining a game outcome including monetary prize amount;
via the display, presenting the skill-based game to the player;
providing an allotted time period for the player to attempt to accomplish said skill-based game via said player interface;
if the player wins the skill-based game in the allotted time period, awarding the player said monetary prize and any bonus prize pool amount; and
if the player fails to win the skill-based game in the allotted time period, not awarding the player said monetary prize and adding said monetary prize amount to said bonus prize pool which is awarded to a next player on any player terminal on the game network to win a skill-based game in an allotted time period.

5. The method of claim 4 further comprising establishing the skill-based game on one or more of the following:
memory;
(ii) trivia;
(iii) dexterity;
(iv) hand-eye coordination; and
(v) pattern recognition.

6. The method of claim 4 further comprising presenting a timer to the player via said display.

7. A system comprising:
a series of networked player terminals wherein said player terminals include at least a display and player user interface; and
a central system in communication with said player terminals and configured to: a) establish a finite pool of game outcomes including monetary prizes; b) accept player wagers or ticket purchases via a player terminal in communication with said central system, said central system in communication with a plurality of player terminals to form a game network, said player terminals including at least a display and player interface; c) select a monetary prize amount and game outcome from said finite pool of game outcomes; d) present to the player a monetary prize that may be won if the player wins the skill-based game in an allotted time period; e) via the display, present the skill-based game to the player; f) provide an allotted time period for the player to attempt to accomplish said skill-based game via said player interface; g) if the player wins the skill-based game in the allotted time period, award the player said monetary prize and any bonus prize pool amount; and h) if the player fails to win the skill-based game in the allotted time period, not award the player said monetary prize and add said monetary prize amount to said bonus prize pool which is awarded to a next player on any player terminal on the game network to win a skill-based game in an allotted time period.

8. The system of claim 7 wherein said central controller is further configured to establish the skill-based game on one or more of the following:
(i) memory;
(ii) trivia;
(iii) dexterity;
(iv) hand-eye coordination; and
(v) pattern recognition.

9. The system of claim 7 wherein said central controller is further configured to present a timer to the player via said display.

10. A system comprising:
a series of networked player terminals wherein said player terminals include at least a display and player user interface;
a central controller in communication with said player terminals and configured to: a) establish a theoretical payout rate based on perfect skill play; b) accept player wagers via a player terminal in communication with a central system, said central system in communication with a plurality of player terminals to form a game network, said player terminals including at least a display and player interface; c) randomly determine a game outcome including monetary prize amount; d) via the display, present the skill-based game to the player; e) provide an allotted time period for the player to attempt to accomplish said skill-based game via said player interface; f) if the player wins the skill-based game in the allotted time period, award the player said monetary prize and any bonus prize pool amount; and g) if the player fails to win the skill-based game in the allotted time period, not award the player said monetary prize and add said monetary prize amount to said bonus prize pool which is awarded to a next player on any player terminal on the game network to win a skill-based game in an allotted time period.

11. The system of claim 10 wherein said central controller is further configured to establish the skill-based game on one or more of the following:
(i) memory;
(ii) trivia;
(iii) dexterity;
(iv) hand-eye coordination; and
(v) pattern recognition.

12. The system of claim 11 wherein said central controller is further configured to present a timer to the player via said display.
